(19) United States
(12) Patent Application Publication
(10) Pub. No.: US 2025/0219278 A1
(43) Pub. Date: Jul. 3, 2025

(54) PATCH ANTENNA WITH HEAT DISSIPATION

(71) Applicant: Elta Systems Ltd., Ashdod (IL)

(72) Inventors: Salomon Marc HANIA, Ashdod (IL); Reuven BAUER, Rehovot (IL)

(21) Appl. No.: 18/983,760

(22) Filed: Dec. 17, 2024

(30) Foreign Application Priority Data
Dec. 27, 2023 (IL) 309781

(51) Int. Cl. H01Q 1/00; H01Q 1/42; H01Q 3/34; H01Q 9/04; H01Q 21/22

(52) U.S. Cl. CPC H01Q 1/002; H01Q 1/42; H01Q 3/34; H01Q 9/0414; H01Q 21/22

(57) ABSTRACT

A patch antenna includes a thermally conductive first patch, an RF feed and a thermally conductive cavity. The thermally conductive first patch is configured to transmit a radio frequency (RF) signal. The RF feed is configured to feed the RF signal to the first patch. The first patch is located within and mechanically connected to the thermally conductive cavity. The thermally conductive cavity is configured to dissipate thermal energy from the first patch.

### TECHNICAL FIELD

The present disclosure, in some embodiments, thereof, relates to a patch antenna and, more particularly, but not exclusively, to a patch antenna for high power operation.

### BACKGROUND

Patch antennas and patch antenna arrays are widely used in various applications due to their low profile, light weight, and ease of integration with other electronic components. However, operating at high power levels can lead to very high temperatures in the antenna itself. Operating at high temperatures may cause several issues. One problem is the degradation of the dielectric material used in the antenna's construction, leading to a shift in the antenna's resonant frequency and a decrease in its efficiency. Additionally, high temperatures may cause thermal expansion of the antenna's substrate, which may lead to changes in the antenna's dimensions and potentially warping of the substrate. These issues may significantly affect the performance of patch antennas operating at high power levels.

### SUMMARY OF THE INVENTION

Embodiments presented herein address the deficiencies of conventional patch antennas and provide a novel patch antenna and patch antenna array capable of operating at very high power levels.

The patch antenna includes one or more patches within a thermally conductive cavity. At least one of the patch radiator(s) is thermally conductive and is mechanically connected to the cavity. The cavity serves as a heat sink which cools the patch or patches, and possibly other components of the antenna (e.g. the RF connector, feed pin, other patches, etc.).

Due to the heat dissipation by the cavity, the antenna may operate at high power levels (e.g. about 1 megawatt) while maintaining a relatively low temperature, possibly tens of degrees lower than a conventional patch antenna operating at the same power.

As used herein, according to some embodiments of the invention, the term “mechanically connected to the cavity” encompasses both the case where the patch radiator and the cavity are the same physical component and the case where the patch radiator and the cavity are different physical components which are mechanically fastened together.

Technical effects of some embodiments of the invention include one or more of:
1) Achieves a high operating power at a low operating temperature relative to conventional patch antennas;
2) Due to the low operating temperature, the thermal damage to antenna components is minimized. This enables using a patch printed on a dielectric material at very high power levels.
3) Electrically conductive cavity is resistant to electrical shocks (such as lightening and static electricity, etc.);
4) Mechanical strength of cavity makes it resistant to physical shocks (such as mechanical stresses during transport, earthquakes, etc.); and
5) The electromagnetic behavior of the antenna is very repeatable.

According to a first aspect of some embodiments of the present invention there is provided a patch antenna. The patch antenna includes:
a thermally conductive first patch, configured to transmit a radio frequency (RF) signal;
an RF feed associated with the first patch, configured to feed the RF signal to the first patch; and
a thermally conductive cavity, wherein the first patch is located within and mechanically connected to the cavity, the cavity being configured to dissipate thermal energy from the first patch.

According to some embodiments of the invention, the first patch and the cavity are separate physical components.

According to some embodiments of the invention, the first patch and the cavity are a single physical component.

According to some embodiments of the invention, the first patch consists of a metallic substance.

According to some embodiments of the invention, the first patch includes an electrically conductive substance on top of a dielectric substrate.

According to some embodiments of the invention, the patch antenna further includes a second patch within the cavity, thermally coupled to the cavity, such that the cavity dissipates thermal energy from the second patch.

According to some embodiments of the invention, the second patch consists of a metallic substance.

According to some embodiments of the invention, the second patch includes an electrically conductive substance on top of a dielectric substrate.

According to some embodiments of the invention, the second patch is a separate physical component from the cavity, and the patch antenna further includes a connecting element configured to mechanically connect the second patch to the cavity so as to create a thermal conduction path from the second patch to the cavity.

According to some embodiments of the invention, the cavity is filled with a dielectric material.

According to some embodiments of the invention, the cavity is electrically conductive and is configured to serve as a ground for at least one patch of the antenna.

According to some embodiments of the invention, the patch antenna further includes a radome covering the cavity.

According to a second aspect of some embodiments of the present invention there is provided a phased array antenna. The phased array antenna includes:
an array of patch antennas, each of the patch antennas respectively comprising:
   a thermally conductive first patch, configured to transmit a radio frequency (RF) signal;
   an RF feed associated with the first patch, configured to feed the RF signal to the first patch; and
   a thermally conductive cavity, wherein the first patch is located within and mechanically connected to the cavity, the cavity being configured to dissipate thermal energy from the first patch; and
a plurality of transmit/receive (TR) modules associated with respective patch antennas, configured to adjust at least one of a respective phase and a respective amplitude of RF signals applied to the patch antennas in accordance with respective control signals, so as to steer a beam of the phased array antenna.

According to some embodiments of the invention, the phased array antenna further includes at least one controller configured to generate the control signals so as to obtain a specified scan angle.

According to some embodiments of the invention, wherein at least one of the patches consists of a metallic substance.

According to some embodiments of the invention, at least one of the patches includes an electrically conductive substance on top of a dielectric substrate.

According to some embodiments of the invention, at least one of the patches includes a second patch within the respective cavity, thermally coupled to the respective cavity, such that the respective cavity dissipates thermal energy from the second patch.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIGS. 1A-1B are simplified section views of a patch antenna with a single patch, according to respective embodiments of the invention;

FIG. 2A is a simplified exploded view of a patch antenna with a single patch, according to an exemplary embodiment of the invention;

FIG. 2B is a simplified isometric view of a patch antenna with a single patch, according to an exemplary embodiment of the invention;

FIGS. 3A-3B are simplified section views of a patch antenna with two patches, according to respective embodiments of the invention;

FIG. 4A is a simplified exploded view of a patch antenna with two patches, according to an exemplary embodiment of the invention;

FIG. 4B is a simplified isometric view of a patch antenna with two patches, according to an exemplary embodiment of the invention;

FIGS. 4C-4Q are simplified illustrations of components of a patch antenna with two patches, according to an exemplary embodiment of the invention;

FIG. 5 is a simplified block diagram of a phased array antenna, according to some embodiments of the invention; and

FIG. 6 is a simplified method for steering a phased array antenna, according to some embodiments of the invention.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to a patch antenna and, more particularly, but not exclusively, to a patch antenna for high power operation.

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### I. Patch Antenna

In some embodiments of the invention, a patch antenna includes at least:
i) A thermally conductive patch for transmitting and/or receiving a radio frequency (RF) signal;
ii) An RF feed that feeds the RF signal to the patch; and
iii) A thermally conductive cavity.
   The patch is located within and mechanically connected to the cavity, so that the cavity dissipates thermal energy from the patch.

Optionally, the patch and the cavity are a single physical component. Alternately, the patch and the cavity are separate physical components which are held together mechanically by a connecting element (e.g. a screw). Exemplary embodiments are presented below.

Optionally, the patch and cavity are a single physical component and are manufactured using a three-dimensional (3D) printer.

The patch antenna may include additional patches for transmitting and/or receiving RF signals (e.g. at different polarizations or different frequency bands).

In some embodiments, the patch antenna is a reciprocal antenna which has the same radiation pattern and polarization when transmitting as it does when receiving. Optionally, the patch antenna is a dual-polarized antenna.

As used herein, according to some embodiments of the invention, the term “antenna” means a device that converts electric current into electromagnetic waves and/or vice versa. The antenna architecture is based on the application it is used for, for example the wavelengths it is required to receive and/or transmit, transmission power, etc.

As used herein, according to some embodiments of the invention, the term “patch” means a component of the antenna that radiates.

### II. Patch(es)

At least part of the patch is a conductive material, so as to enable reception and/or transmission of RF signals.

Optionally, the entire patch is a metallic substance, such as aluminum or stainless steel.

In an alternate embodiment, the patch includes an electrically conductive substance on top of a dielectric substrate. In one example, the patch is supported by the dielectric substrate. In a second example, the patch is an electrically conductive substance (e.g. metal) fabricated on the dielectric substrate (e.g. a microstrip antenna).

In a further embodiment, the patch includes a non-conductive material (e.g. plastic) plated with a conductive material.

Examples of materials that may be used as dielectric substrates include but are not limited to: polytetrafluoroethylene (PTFE), epoxy glass, ceramics, foam, polystyrene, Poly(methyl methacrylate) (PMMA), fused quartz, alumina, and silicon.

Optionally, the patch antenna further includes a second patch that is located within the cavity. The second patch is thermally coupled to the cavity, such that the cavity dissipates thermal energy for both patches. At least part of the second patch is a conductive material, so as to enable reception and/or transmission of RF signals. Optionally, the second patch is a separate physical component from the cavity and is mechanically connected to the cavity by a connecting element (e.g. a screw). The mechanical connection creates a thermal conduction path from the second patch to the cavity.

In a first embodiment, the entire second patch is a metallic substance.

In a second embodiment, the second patch includes an electrically conductive substance on top of a dielectric substrate. In one example, the second patch is supported by the dielectric substrate. In a second example, the second patch is an electrically conductive substance (e.g. metal) fabricated on the dielectric substrate.

In a third embodiment, the patch includes a non-conductive material (e.g. plastic) plated with a conductive material.

The shape of the patch may be any shape suitable for the particular implementation.

Optionally, the first patch and second patch have different geometrical shapes.

Optionally, at least one patch in the patch antenna is symmetrical on both the x-axis and the y-axis (e.g. square, circular, etc.). Alternately or additionally, at least one patch in the patch antenna is asymmetrical on at least one axis (e.g. triangular, trapezoidal, etc.).

In further optional embodiments, the patch antenna includes three or even more patches with the cavity. The additional patches may respectively include some or all of the properties described herein for the first and/or second patches.

### III. Cavity

In some embodiments, the cavity serves as a heat sink, dissipating heat from the first patch, and optionally from other components of the antenna (e.g. the RF feed).

Optionally, the cavity is electrically conductive and serves as a ground for the first patch. In embodiments where the antenna includes multiple patches, the cavity optionally serves as ground for more than one patches, providing there is high enough electrical conductivity between the patches and the electrically conductive cavity. Optionally, the cavity is metallic.

Optionally, the cavity is structured so that a portion of it is a mechanical support with high thermal conductivity. The mechanical support supports the patch(es), which may extend beyond it on the horizontal plane.

Optionally, the shape of the mechanical support is symmetrical in the x and y axes (circular, square, etc.).

The mechanical support may be electrically conductive (e.g. metallic) or not conductive (e.g. aluminum nitrite).

Optionally, the mechanical support is electrically conductive and serves as part of a ground connection.

Optionally, the mechanical support is positioned in the center of the patch(es) where the electrical field is zero.

Optionally, the mechanical support is not electrically conductive. In this case the mechanical support may be positioned off the center of the patch (e.g. closer to one side).

Optionally, the cavity is filled with a dielectric material. Further optionally, the cavity is filled with air. One advantage of not filling the cavity with foam may reduce the buildup of humidity in the cavity, thereby preventing damage to the antenna.

### IV. Radome

Optionally, the patch antenna includes a radome covering the cavity. The radome may be formed from a dielectric material.

Further optionally, there is an adhesive or other type of supportive layer between the radome and the uppermost patch within the cavity. Alternately or additionally, the radome is fastened to the other antenna components by a screw or other mechanical connecting element.

### V. Transmit/receive (T/R) Module

Optionally, the RF feed is connected to RF transmitting and/or receiving equipment via a transmit/receive (T/R) module. The T/R module adjusts the phase and/or amplitude of the signal applied to the RF feed in accordance with control signals. The T/R module may have any architecture suitable for controlling the phase and/or amplitude of an RF signal.

Optionally the T/R module is capable of adjusting the phase and amplitude of both received and transmitted RF signals.

### VI. Exemplary Single Patch Antenna

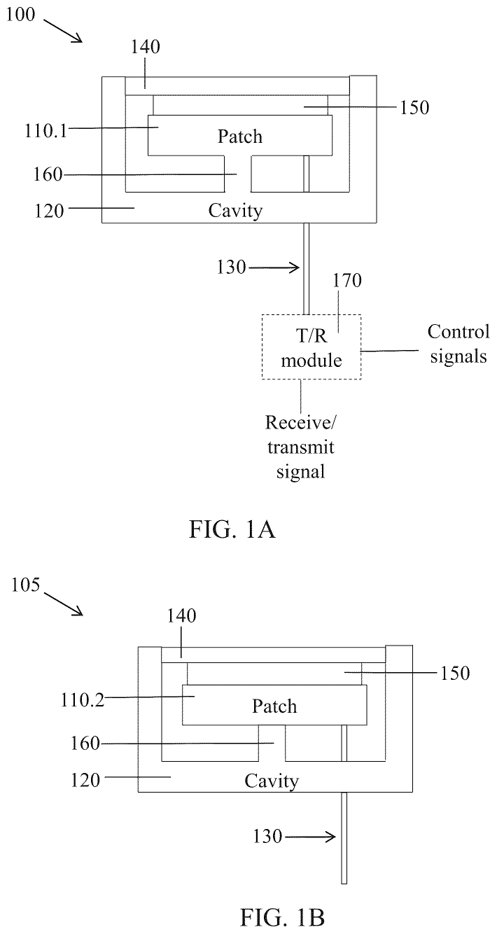

Referring now to the drawings, FIGS. 1A-1B are simplified section views of a patch antenna with a single patch, according to respective embodiments of the invention. FIG. 1A is of a patch antenna in which the patch and cavity are the same physical component. FIG. 1B is of a patch antenna in which the patch and cavity are the separate physical components, which are mechanically connected by a connecting element (not shown).

Referring to FIG. 1A, patch antenna 100 includes:
i) Patch 110.1—is thermally conductive and is configured to emit and/or receive a radio frequency (RF) signal;
ii) Cavity 120 is a thermally conductive cavity; and
iii) RF feed 130 feeds the RF signal to patch 110.1.

In FIG. 1A, patch 110.1 and cavity 120 are a single physical unit. A portion of cavity 120 is mechanical support 160 that supports patch 110.1 which typically extends beyond the mechanical support. Patch 110.1 and cavity 120 (including mechanical support 160) have high thermal conductivity, so that heat is dissipated from patch 110.1 by cavity 120.

Mechanical support 160 supports the patch at its the center. The electric field at the center is zero, therefore mechanical support 160 has no effect on the electromagnetic behavior of patch antenna 100.

Optionally, the RF feed 130 is connected to T/R module 170, which adjusts the phase and/or amplitude of the signal fed to and/or received from patch 110.1. The amplitude and/or phases are controlled by control signals. The use of T/R modules is significant for beam steering of phased array antennas, as presented below.

Referring to FIG. 1B, patch antenna 105 includes:
i) Patch 110.2—is thermally conductive and is configured to transmit and/or receive a radio frequency (RF) signal;
ii) Cavity 120 is a thermally conductive cavity; and
iii) RF feed 130 feeds the RF signal to patch 110.2.

FIG. 1B illustrates an embodiment in which patch 110.2 and cavity 120 are separate physical units, connected by a mechanical connecting element (not shown). A portion of cavity 120 is formed as a mechanical support 160 that supports patch 110.2. Patch 110.2, cavity 120 and mechanical support 160 all have high thermal conductivity, so that heat is dissipated from patch 110.2 by cavity 120.

Similarly to FIG. 1A, mechanical support 160 supports the patch at its the center where the electric field is zero and therefore has no effect on the electromagnetic behavior of patch antenna 105.

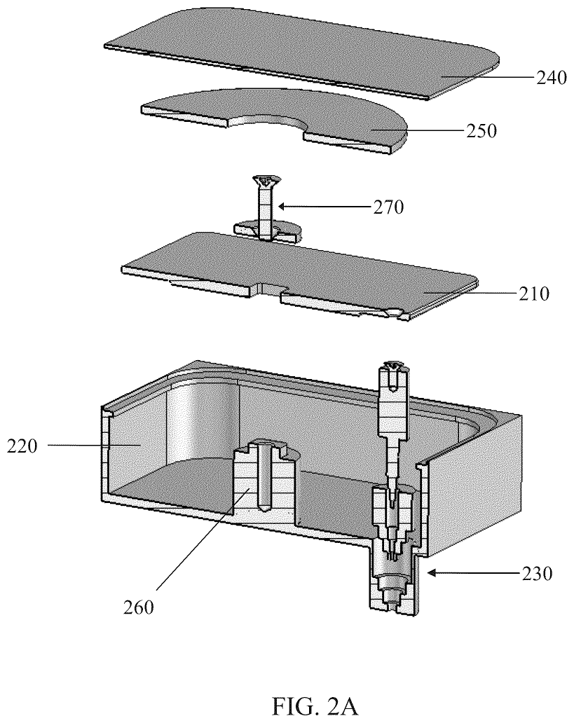

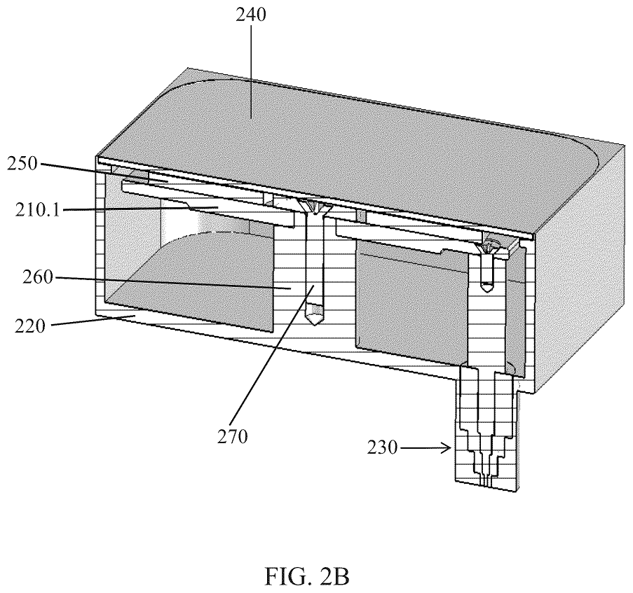

FIG. 2A is a simplified exploded view of a patch antenna with single patch, according to an exemplary embodiment of the invention. FIG. 2B is a simplified isometric view of the patch antenna of FIG. 2A.

Patch 210 is a substantially rectangular patch located within cavity 220. RF feed 230 feeds the RF signal to and/or from patch 210. Radome 240 covers cavity 220 and is separated from patch 210 by adhesive layer 250.

In the exemplary embodiment of FIGS. 2A-2B, patch 210 is a separate component from cavity 220. Patch 210 fits onto the mechanical support portion 260 of cavity 220 and is secured to cavity 220 by connecting element 270.

### VII. Exemplary Dual-Patch Antenna

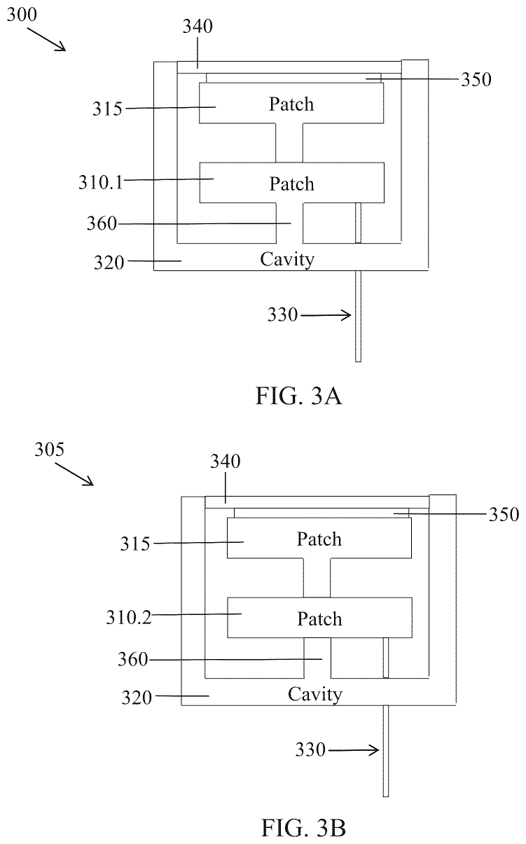

FIGS. 3A-3B are simplified section views of a patch antenna with two patches, according to respective embodiments of the invention. FIG. 3A is of a patch antenna in which the first patch and the cavity are the same physical component. FIG. 3B is of a patch antenna in which the first patch and the cavity are the separate physical components, which are connected by a connecting element. In both examples, the second patch is a separate physical component.

Referring to FIG. 3A, patch antenna 300 includes:
i) Patch 310.1 is a thermally conductive first patch which is configured to transmit and/or receive a radio frequency (RF) signal;
ii) Patch 315 is a thermally conductive second patch which is configured to transmit and/or receive a radio frequency (RF) signal;
iii) Cavity 320 is a thermally conductive cavity; and
iv) RF feed 330 feeds the RF signal to patch 310.1.

In FIG. 3A, patch 310.1 and cavity 320 are a single physical unit and patch 315 is a separate physical component. A portion of patch 310.1 and cavity 320 is mechanical support 360 that supports patches 310.1 and 315, which typically extend beyond the mechanical support. Patch 315 is connected to patch 310.1 and cavity 320 by a mechanical connecting element (not shown). Patch 310.1, patch 315 and cavity 320 (including mechanical support 360) have high thermal conductivity, so that heat is dissipated from patches 310.1 and 315 by cavity 320.

Referring to FIG. 3B, patch antenna 305 includes:
i) Patch 310.2 is a thermally conductive first patch which is configured to transmit and/or receive a radio frequency (RF) signal;
ii) Patch 315 is a thermally conductive second patch which is configured to transmit and/or receive a radio frequency (RF) signal;
iii) Cavity 320 is a thermally conductive cavity; and
iv) RF feed 330 feeds the RF signal to patch 310.2.

FIG. 3B illustrates an embodiment in which patch 310.2, patch 315 and cavity 320 are three separate physical units, which are connected together by a mechanical connecting element (not shown). Patch 310.2, patch 315 and cavity 320 all have high thermal conductivity, so that heat is dissipated by cavity 320 from patch 310.2 and patch 315.

In both embodiments of FIGS. 3A-3B, mechanical support 360 supports the patch at its the center where the electric field is zero, and therefore has no effect on the electromagnetic behavior of the patch antenna.

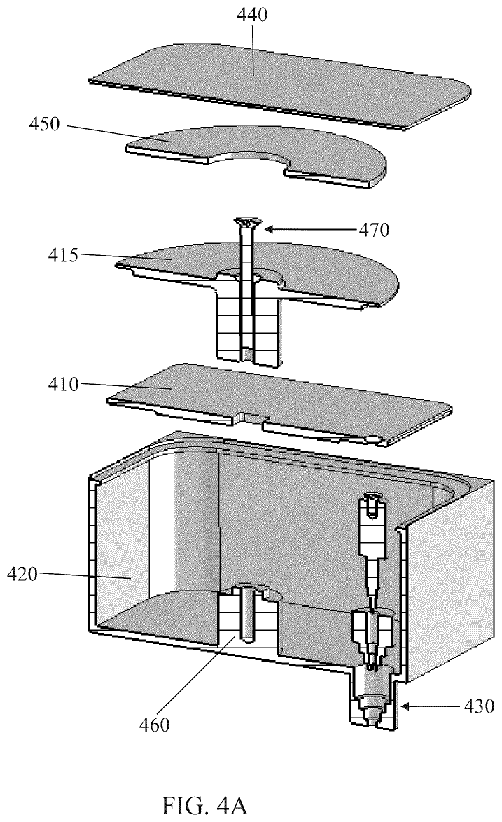

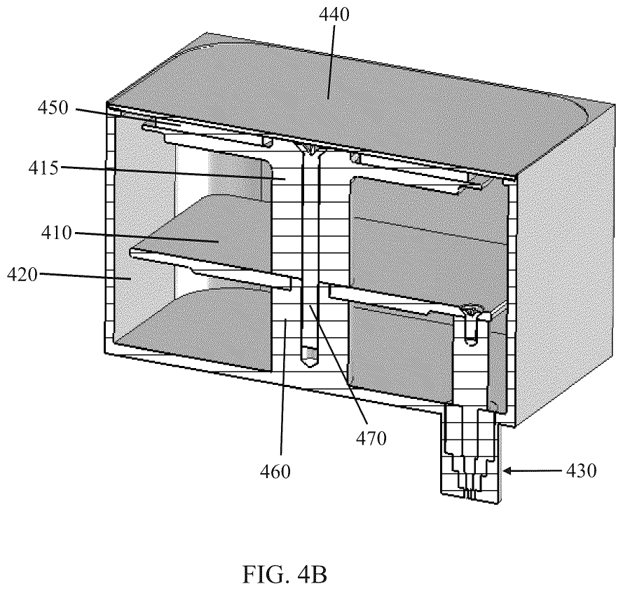

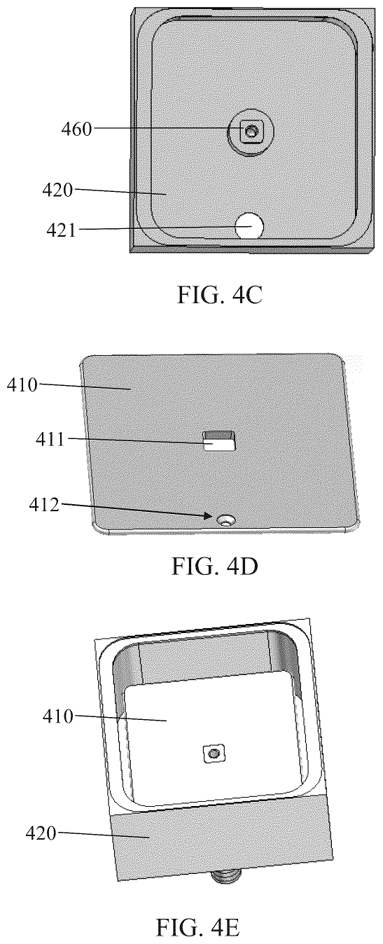

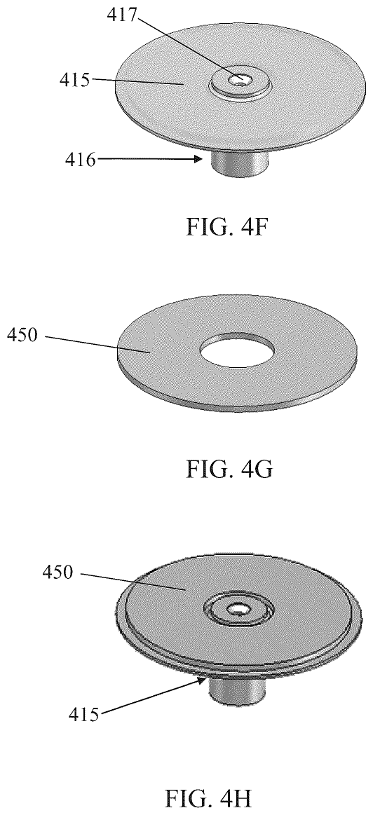

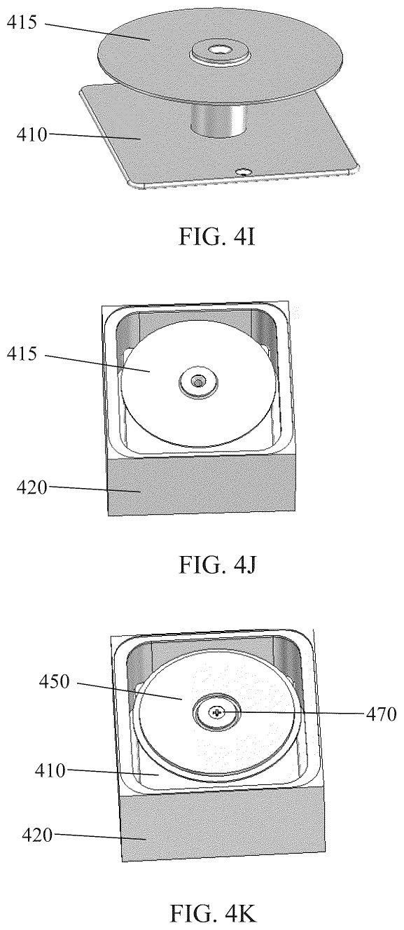

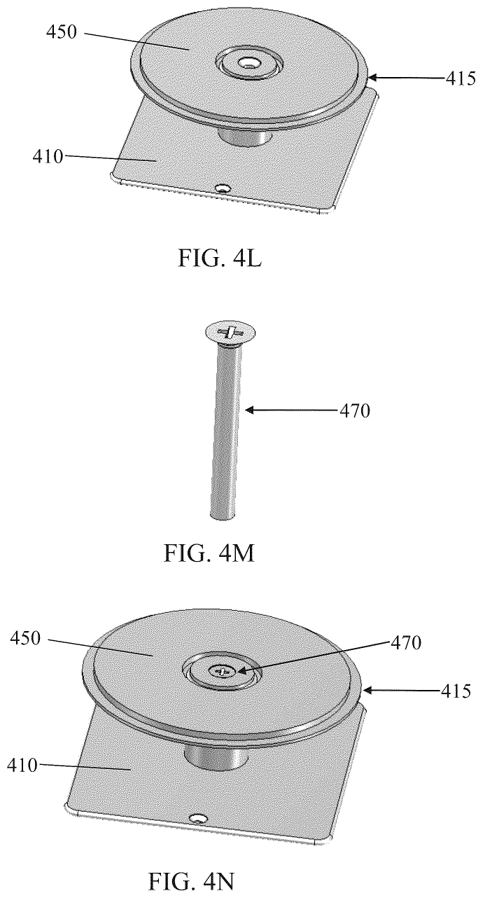

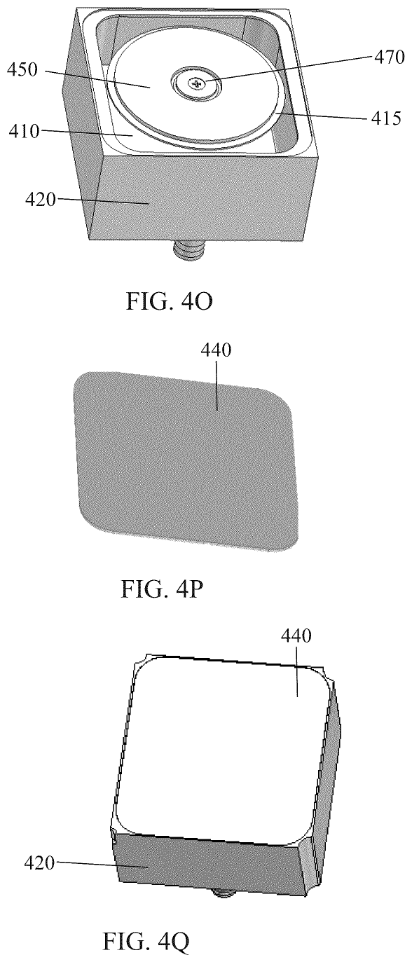

FIG. 4A is a simplified exploded view of a patch antenna with two patches, according to an exemplary embodiment of the invention. FIG. 4B is a simplified isometric view of the patch antenna of FIG. 4A.

Patch 410 is a substantially rectangular patch located within cavity 420. Patch 410 is a substantially circular patch, stacked above patch 410 within cavity 420. Using a circular upper patch may be advantageous because it is always symmetric relative to the bottom patch, thereby preventing the misalignment that may occur with two square or rectangular patches.

RF feed 430 feeds the RF signal to and/or from patch 410. Radome 440 covers cavity 420 and is separated from patch 415 by adhesive layer 450.

In the exemplary embodiment of FIGS. 4A-4B, patch 410, patch 415 and cavity 420 are separate physical components. Patch 410 fits onto the mechanical support portion 460 of cavity 420. Patch 420 is supported by patch 410. Patch 410, patch 415 and cavity 420 are secured together by connecting element 470.

Reference is now made to FIGS. 4C-4Q, which are simplified illustrations of components of a patch antenna with two patches, according to the exemplary embodiment of FIG. 4B. The shapes, connections, circuitry, and other aspects shown herein are non-limiting with regard to other possible embodiments of the invention.

FIG. 4C is a top view of an exemplary cavity 420, showing mechanical support 460 protruding from the bottom of cavity 420. Mechanical support 460 has a hole which the connecting element passes through. Cavity 420 has opening 421, through which the feed line passes to reach patch 410.

FIG. 4D illustrates an exemplary first patch 410. Patch 410 has opening 411 sized to fit around the cavity's mechanical support, and feed input 412 which connects to the RF feed.

FIG. 4E is a top view of patch 410 within cavity 420.

FIG. 4F illustrates exemplary second patch 415. A portion of patch 415 is formed as a support 416, which supports patch 415 on patch 410. Patch 415 has a hole which the connecting element passes through.

FIG. 4G illustrates an exemplary adhesive layer 450, which is present between second patch 415 and radome 440.

FIG. 4H illustrates adhesive layer 450 on the second patch 415.

FIG. 4I illustrates second patch 415 positioned upon first patch 410.
FIG. 4J illustrates second patch 415 positioned upon first patch 410, inside cavity 420.

FIG. 4K illustrates adhesive layer 450, second patch 415 and first patch 410, all located within cavity 420. Adhesive layer 450, second patch 415 and first patch 410 and cavity 420 are secured together by connecting element 470.

FIG. 4L illustrates second patch 415 positioned upon first patch 410. Adhesive layer 450 is on top of patch 415.

FIG. 4M illustrates an exemplary mechanical connecting element 470.
FIG. 4N illustrates adhesive layer 450, second patch 415 and first patch 410, secured together by mechanical connecting element 470.

FIG. 4O illustrates adhesive layer 450, second patch 415 and first patch 410, located within cavity 420 and secured together by mechanical connecting element 470.

FIG. 4P illustrates an exemplary radome 440.

FIG. 4Q illustrates cavity 420 covered by radome 440.

### VIII. Phased Array Antenna

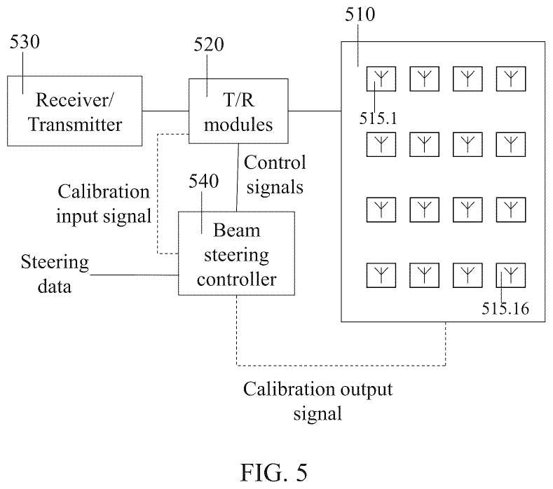

Reference is now made to FIG. 5, which is a simplified block diagram of a phased array antenna, according to some embodiments of the invention.

As used herein, according to some embodiments of the invention, the term “phased array antenna” means an array of antennas that is controlled to produce a desired radiation pattern.

The phased array antenna includes patch antenna array 510 and T/R modules 520. For clarity, patch antenna array 510 is illustrated in a non-limiting manner as a four by four array of patch antennas 515.1-515.16. As will be appreciated by the skilled person, other configurations of patch antennas may be used.

Optionally, each of the patch antennas includes:
i) At least one thermally conductive patch for transmitting and/or receiving a radio frequency (RF) signal;
ii) An RF feed that feeds the RF signal to the patch antenna; and
iii) A thermally conductive cavity.

One or more of the patch(es) is located within and mechanically connected to the cavity, so that the cavity dissipates thermal energy from the patch(es).

Optionally, at least one of the patch antennas includes a radome covering the cavity.

Optionally, at least one of the patch antennas includes a top dielectric layer between the uppermost patch and the radome.

Optionally, at least one of the patch antennas includes a mechanical connecting element forming a mechanical connection between physically separate components of the patch antenna (e.g. between the cavity, first patch and second patch).

T/R modules 520 adjust the respective phases and amplitudes of signals transmitted by and/or received from the patches. The phases and amplitudes are adjusted based on respective control signals provided to T/R modules 520.

Optionally, the phased array antenna includes beam steering controller 540 which steers the phased array antenna beam by generating the control signals for T/R modules 520. Beam steering controller 540 may include analog and/or digital circuitry.

Optionally, beam steering controller 540 includes at least one data processor, which may serve, for example, to determine the respective magnitudes of the control signals to obtain a specified scan angle. Optionally, the direction is determined from steering data obtained from a system controller.

Optionally, beam steering controller 540 includes at least one memory (volatile and/or non-volatile) for storing instructions for execution by the processor and/or data.

Optionally, beam steering controller 540 includes at least one analog to digital (A/D) converter that generates analog control signals for the T/R elements.

Alternately or additionally, the A/D converter(s) digitize calibration output signals returned from antenna array 510 during a calibration process. Beam steering circuitry may use the digitized calibration signals to calculate correction factors for the control signals in order to steer the antenna beam accurately.

Optionally, beam steering controller 540 includes a digital signal processor for processing the digitized calibration signals.

In some embodiments of the invention, the phased array antenna includes at least one calibration line running between the patch antennas 515. During the calibration process, a calibration input signal is provided to each polarization of the individual patch antennas and/or groups of patch antennas in turn. The amplitude and phase shift of the resulting output calibration signal are measured, and respective amplitude and phase correction factors are calculated for of the patch antennas.

Optionally, phased array antenna 510 is connected via T/R modules 520 to a receiver and/or transmitter, shown schematically as receiver/transmitter 530.

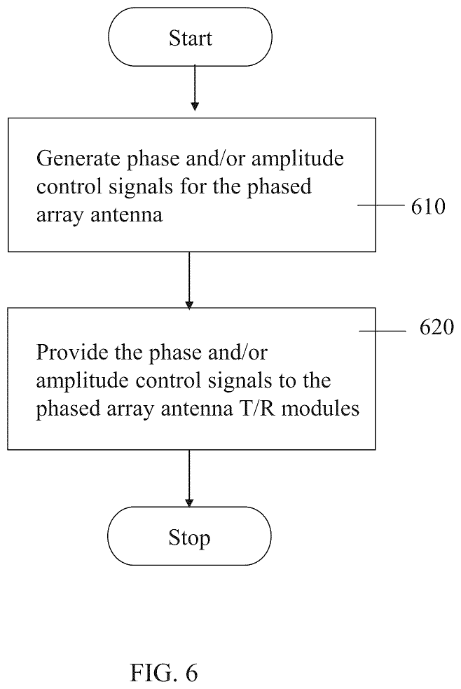

Reference is now made to FIG. 6, which is a simplified method for steering a phased array antenna, according to some embodiments of the invention.

In 610, control signals respective control signals are generated for the patch antennas of a phased array antenna so as to obtain a specified scan angle. The phased array antenna includes an array of patch antennas and T/R modules for adjusting respective phases and/or amplitudes of the patch antennas. The patch antennas in the array may be any embodiment of the patch antenna described herein.

Optionally, each of the patch antennas in the array includes:
i) At least one thermally conductive patch for transmitting and/or receiving a radio frequency (RF) signal;
ii) An RF feed that feeds the RF signal to the patch antenna; and
iii) A thermally conductive cavity.
   One or more of the patch(es) is located within and mechanically connected to the cavity, so that the cavity being dissipates thermal energy from the patch(es).

Optionally, at least one of the patch antennas includes a radome covering the cavity.

Optionally, at least one of the patch antennas includes a top dielectric layer between the uppermost patch radiator and the radome.

Optionally, the method further includes generating the control signals for the T/R modules based on the correction factors and the desired scan angle.

In 620, the control signals are provided to the T/R modules.

### IX. Results

A thermal analysis was performed for an antenna according to an exemplary embodiment of the invention. In the analysis, the exemplary antenna was excited with a 500 Watts continuous wave. The highest temperatures were found in the vicinity of the antenna feed. The maximum temperature reached was 61° C. on the feed's Teflon sleeve. The maximum temperature of the cavity and the radome was 45° C. This thermal analysis demonstrates the efficacy of the cooling mechanism described herein, whereby the antenna temperature remained in an operational range despite the extreme power inputted into the antenna.

### General

It is expected that during the life of a patent maturing from this application many relevant patches, radomes, cavities, mechanical connecting elements and materials used in patch antennas will be developed and the scope of the terms patch, radome, cavity and mechanical connecting element are intended to include all such new technologies a priori.

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1. A patch antenna, comprising:
a thermally conductive first patch, configured to transmit a radio frequency (RF) signal;
an RF feed associated with said first patch, configured to feed said RF signal to said first patch; and
a thermally conductive cavity, wherein said first patch is located within and mechanically connected to said cavity, said cavity being configured to dissipate thermal energy from said first patch.

2. The patch antenna of claim 1, wherein said first patch and said cavity comprise separate physical components.

3. The patch antenna of claim 1, wherein said first patch and said cavity comprise a single physical component.

4. The patch antenna of claim 1, wherein said first patch consists of a metallic substance.

5. The patch antenna of claim 1, wherein said first patch comprises an electrically conductive substance on top of a dielectric substrate.

6. The patch antenna of claim 1, further comprising a second patch within said cavity, thermally coupled to said cavity, such that said cavity dissipates thermal energy from said second patch.

7. The patch antenna of claim 6, wherein said second patch consists of a metallic substance.

8. The patch antenna of claim 6, wherein said second patch comprises an electrically conductive substance on top of a dielectric substrate.

9. The patch antenna of claim 6, wherein said second patch comprises a separate physical component from said cavity, said patch antenna further comprising a connecting element configured to mechanically connect said second patch to said cavity so as to create a thermal conduction path from said second patch to said cavity.

10. The patch antenna of claim 1, wherein said cavity is filled with a dielectric material.

11. The patch antenna of claim 1, wherein said cavity is electrically conductive and is configured to serve as a ground for at least one patch of said antenna.

12. The patch antenna of claim 1, further comprising a radome covering said cavity.

13. A phased array antenna, comprising:
an array of patch antennas, each of said patch antennas respectively comprising:
a thermally conductive first patch, configured to transmit a radio frequency (RF) signal;
an RF feed associated with said first patch, configured to feed said RF signal to said first patch; and
a thermally conductive cavity, wherein said first patch is located within and mechanically connected to said cavity, said cavity being configured to dissipate thermal energy from said first patch; and
a plurality of transmit/receive (TR) modules associated with respective patch antennas, configured to adjust at least one of a respective phase and a respective amplitude of RF signals applied to said patch antennas in accordance with respective control signals, so as to steer a beam of said phased array antenna.

14. The phased array antenna according to claim 13, further comprising at least one controller configured to generate said control signals so as to obtain a specified scan angle.

15. The phased array antenna according to claim 13, wherein at least one of said patches consists of a metallic substance.

16. The phased array antenna according to claim 13, wherein at least one of said patches comprises an electrically conductive substance on top of a dielectric substrate.

17. The phased array antenna according to claim 13, wherein at least one of said patches comprises a second patch within said respective cavity, thermally coupled to said respective cavity, such that said respective cavity dissipates thermal energy from said second patch.
